(19) United States
(12) Patent Application Publication
(10) Pub. No.: US 2020/0143408 A1
(43) Pub. Date: May 7, 2020

(54) TEST-DRIVING MANAGEMENT METHOD AND TEST-DRIVING MANAGEMENT DEVICE

(71) Applicant: HONDA MOTOR CO., LTD., Tokyo (JP)

(72) Inventor: Daisuke Sawai, Wako-shi (JP)

(21) Appl. No.: 16/660,946

(22) Filed: Oct. 23, 2019

(30) Foreign Application Priority Data
Nov. 1, 2018 (JP) 2018-206529

(51) Int. Cl. G06Q 30/02

(52) U.S. Cl. CPC G06Q 30/0224; G06Q 30/0235

(57) ABSTRACT

A test-driving management method performed by one or more computers includes: acquiring a test-driving request of a user transmitted by a terminal device; selecting a moving object that matches a request of the test-driving request from moving objects for test-driving registered in advance; determining whether a provider of the selected moving object responds to the test-driving request; and granting a reward provided by a seller of the moving object to the provider after the provider responds to the test-driving request or after the user performs the test-driving on the moving object.

### CROSS-REFERENCE TO RELATED APPLICATION

Priority is claimed on Japanese Patent Application No. 2018-206529, filed Nov. 1, 2018, the content of which is incorporated herein by reference.

### BACKGROUND

### Field of the Invention

The present invention relates to a test-driving management method and a test-driving management device.

### Description of Related Art

In the related art, a system in which a reservation application for rental is transmitted from a user terminal to a support server, an approval for the reservation of the rental is transmitted from an owner terminal to the support server, and car rental is performed between individuals has been disclosed (for example, Japanese Unexamined Patent Application, First Publication No. 2018-28850).

### SUMMARY

However, the above technology of the related art relates to a system that merely performs rental between users and test-driving on a moving object has not been considered.

The present invention is devised in view of such circumstances and an object of the present invention is to provide a test-driving management method and a test-driving management device capable of improving convenience for a seller, a purchaser, or a user of a moving object by utilizing test-driving on the moving object.

For a test-driving management method and a test-driving management device according to the present invention, the following configurations are adopted.

(1) According to an aspect of the present invention, a test-driving management method performed by one or more computers is provided. The method includes: acquiring a test-driving request of a user transmitted by a terminal device; selecting a moving object that matches a request of the test-driving request from moving objects for test-driving registered in advance; determining whether a provider of the selected moving object responds to the test-driving request; and granting a reward provided by a seller of the moving object to the provider after the provider responds to the test-driving request or after the user performs the test-driving on the moving object.

(2) The test-driving management method according to the aspect (1) may further include: acquiring information regarding an action estimated to be performed by the user after the user performs the test-driving for the test-driving request; and setting the reward based on the acquired information.

(3) The test-driving management method according to the aspect (1) or (2) may further include: acquiring purchase information indicating that the user has purchased one or more moving objects, a product, and a service (hereinafter referred to as selling targets) from the seller; and performing setting to increase the reward for the provider when the purchase information is acquired within a predetermined period after the test-driving compared with when the purchase information is not acquired within the predetermined period.

(4) The test-driving management method according to any one of the aspects (1) to (3) may further include: specifying a selling target purchased by the user among a moving object, a product, or a service (hereinafter referred to as selling targets) from the seller; and setting the reward in accordance with the specified selling target.

(5) The test-driving management method according to any one of the aspects (1) to (4) may further include: checking a selling situation of the moving object for which the test-driving is requested in the test-driving request of the user; and transmitting, to a terminal device, guidance for the test-driving on a moving object having a type which is similar to the type of moving object requested for the test-driving in the test-driving request of the user and is handled by the seller when the moving object requested with the test-driving request is not handled by the seller at a time point at which the test-driving request is transmitted or on a scheduled day of test-driving requested in the test-driving request.

(6) The test-driving management method according to the aspect (5) may further include: acquiring information indicating whether a terminal device of a user having transmitted the guidance on the test-driving of a similar type of moving object has approved of the test-driving on the similar type of moving object; and transmitting information regarding the seller selling the moving object for which the test-driving is requested to the terminal device of the user when the user does not approve of the test-driving of the similar type of moving object.

(7) The test-driving management method according to any one of the aspects (1) to (4) may further include: acquiring information indicating whether a provider of a moving object on which the user performs the test-driving rides together in the test-driving; and increasing the reward when the information indicating that the provider rides together is acquired compared with when the information indicating the provider rides together is not acquired.

(8) The test-driving management method according to any one of the aspects (1) to (7) may further include: acquiring an assessment regarding a user performing the test-driving on a moving object requested with the test-driving request after the test-driving; and acquiring an assessment regarding a provider providing the moving object requested with the test-driving request after the test-driving.

(9) The test-driving management method according to the aspect (8) may further include determining a privilege to be granted to the user or limiting a service to be provided to the user based on the assessment regarding the user.

(10) The test-driving management method according to the aspect (8) or (9) may further include setting the reward by further adding an assessment regarding a provider providing the moving object.

(11) The test-driving management method according to the aspects (1) to (10) may further include: acquiring state information indicating a current state of a moving object for test-driving registered in advance; determining whether the moving object is a candidate moving object for the test-driving requested with the test-driving request based on the acquired state information; and performing a notification to prompt a terminal device of the provider of the moving object determined to be a candidate moving object to permit the test-driving.

(12) The test-driving management method according to the aspect (11) may further include: determining whether the moving object is a moving object on which the test-driving is possible based on the acquired state information; and performing a notification to recommend the test-driving on the moving object to a terminal device of a user who has an authority to transmit the test-driving request when the moving object is determined to be a moving object on which the test-driving is possible.

(13) The test-driving management method according to any one of the aspects (1) to (12) may further include: causing a storage to store information regarding a user performing the test-driving; specifying a user manifesting an intention to purchase one selling target among a moving object, a product, and a service (hereinafter referred to as selling targets); and granting a privilege of purchasing the selling target when the specified user is identical to the user stored in the storage.

(14) The test-driving management method according to any one of the aspects (1) to (13) may further include: specifying a first user who performs the test-driving and purchases a moving object; specifying a second user who purchases a moving object without performing test-driving; receiving registration of the purchased moving object set as a moving object for the test-driving; and giving preference to a reward granted to the first user when the moving object registered by the first user is used for the test-driving to a reward granted to the second user when the moving object registered by the second user is used for the test-driving.

(15) The test-driving management method according to any one of the aspects (1) to (14) may further include: acquiring a first index related to the test-driving request; acquiring a second index related to the moving object which is able to be provided in response to the test-driving request; and adjusting first degree and second degree based on the acquired first and second indexes, the first degree being a degree of reward granted to a provider providing a moving object in response to the test-driving request, the second degree being a degree of reward granted to a receiver transmitting the test-driving request and performing test-driving on the moving object.

(16) According to another aspect of the present invention, a test-driving management device is provided, including: a first acquirer configured to acquire a test-driving request of a user transmitted by a terminal device; a selector configured to select a moving object that matches a request of the test-driving request from moving objects for test-driving registered in advance; a determiner configured to determine whether a provider of the selected moving object responds to the test-driving request; and a granter configured to grant a reward provided by a seller of the moving object to the provider after the provider responds to the test-driving request or after the user performs the test-driving on the moving object.

According to the aspects (1), (2), and (16), it is possible to improve convenience for a seller, a purchaser, or a user of a moving object by utilizing test-driving on the moving object. For example, it is not necessary for a seller such as a store of the moving object to own the moving object in each district or the number of owned moving objects for the test-driving owned by the seller can be reduced. The owner of the moving object can obtain a reward when the moving object is used for the test-driving.

According to the aspect (3), selling of the moving object related to the test-driving by the owner of the moving object can be expected to be promoted. As a result, a sales promotion activity of the seller is complemented.

According to the aspect (4), it is possible to set a reward in accordance with sales requirements of the seller.

According to the aspect (5), it is possible to promote sales of the moving object sold at present.

According to the aspect (6), by introducing a partner even when a used moving object is requested, it is possible to obtain trust in a user and improve a likelihood of the user becoming a future customer of a seller.

According to the aspect (7), since a reward can be obtained in accordance with the degree of contribution to promotion, it is possible to obtain active cooperation of the provider.

According to the aspect (8), it is possible to prevent the provider excessively soliciting the user or the like and prompt the provider to assess the moving object appropriately. Further, it is possible to prompt the user to perform appropriate test-driving.

According to the aspect (9) or (10), since a privilege or a reward is determined based on the assessment or the service is restricted, a more appropriate test-driving service is expected to be provided.

According to the aspect (11), since whether it is possible to perform the test-driving is determined in real time, it is possible to respond promptly to the test-driving request and guarantee the types of moving objects on which the test-driving is possible.

According to the aspect (12), in a time in which the moving object is not used, it is possible to prompt utilization of the moving object in the test-driving.

According to the aspect (13), by allowing the user to perform the test-driving, it is possible to actively prompt purchase of the moving object.

According to the aspect (14), it is possible to prompt use of the service related to the test-driving.

According to the aspect (15), since a balance between supply and demand is provided, it is possible to promote utilization of the test-driving service.

### BRIEF DESCRIPTION OF THE DRAWINGS

FIG. 1 is a diagram showing a configuration of a test-driving system including a test-driving management device.

FIG. 2 is a diagram showing an overview of a process in the test-driving system.

FIG. 3 is a sequence diagram showing a flow of a process related to registration and a test-driving reservation of a service provider.

FIG. 4 is a diagram showing an example of content of service provider information.

FIG. 5 is a diagram showing an example of an input screen of a test-driving request.

FIG. 6 is a diagram showing an example of content of request information.

FIG. 7 is a diagram showing an example of content of schedule information.

FIG. 8 is a diagram showing another flow of the process related to test-driving reservation.

FIG. 9 is a diagram showing an example of content of recommendation information.

FIG. 10 is a diagram showing an example of a mutual authentication image.

FIG. 11 is a diagram showing an example of content of assessment information of a service receiver.

FIG. 12 is a diagram showing an example of content of assessment information of a service provider.

FIG. 13 is a diagram showing a flow of a process of providing a reward.

FIG. 14 is a sequence diagram showing an example of a flow of a process performed by the test-driving system.

FIG. 15 is a diagram showing an example of content of reward management information.

FIG. 16 is a diagram showing an example of a configuration of a test-driving system according to a second embodiment.

FIG. 17 is a sequence diagram showing a flow of a process performed by the test-driving system according to the second embodiment.

FIG. 18 is a flowchart showing an example of a flow of a process performed by a test-driving management device according to a third embodiment.

FIG. 19 is a diagram showing an example of an image including first reward distribution information displayed on a display of a terminal device.

FIG. 20 is a diagram showing an example of an image including second reward distribution information displayed on the display of the terminal device.

FIG. 21 is a diagram showing a reward determination scheme.

FIG. 22 is a diagram showing an example of a hardware configuration of a test-driving management device according to an embodiment.

### DESCRIPTION OF EMBODIMENTS

Hereinafter, embodiments of a test-driving management method and a test-driving management device according to the present invention will be described with reference to the drawings.

In the following description, a service providing test-driving on a four-wheeled vehicle which is a moving object will be described. However, a service providing test-driving on other moving objects other than a four-wheeled vehicle may be applied to a test-driving management method and a test-driving management device. The moving objects include a two-wheeled vehicle, a three-wheeled vehicle, a general-purpose product (including an agricultural machine such as a tractor, a snow blower, an electric cart), a marine use product (a ship on which an outboard motor is mounted), an airplane, and an unmanned aerial vehicle (UAV). The moving object may be, for example, a moving object such as an automated driving vehicle that moves autonomously.

### First Embodiment

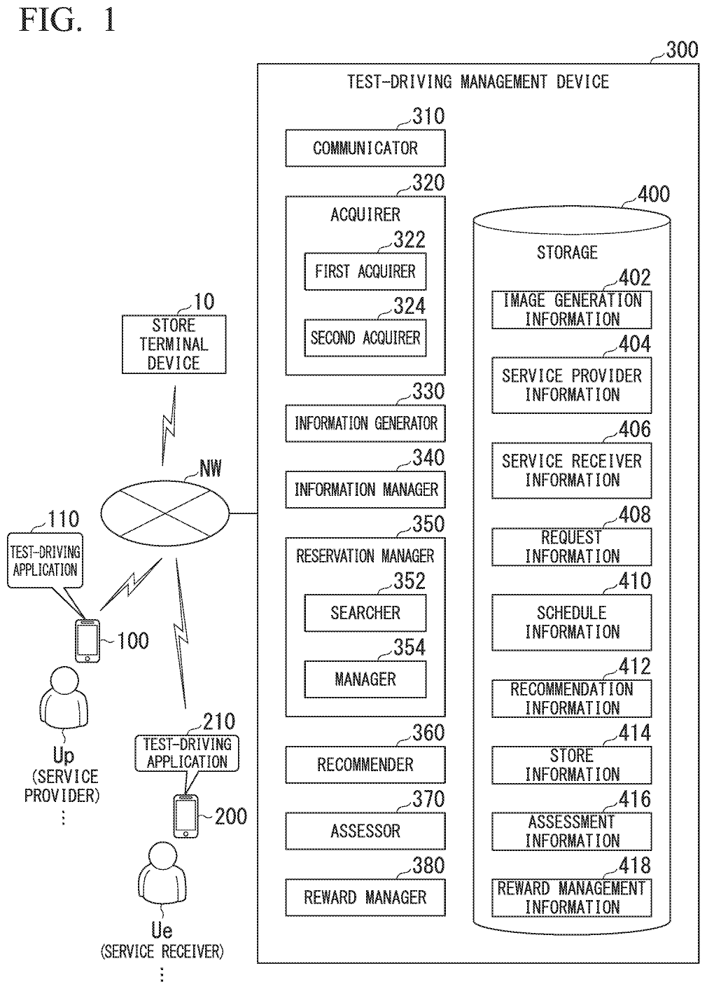

FIG. 1 is a diagram showing a configuration of a test-driving system 1 including a test-driving management device 300. The test-driving system 1 includes one or more store terminal devices 10, one or more terminal devices 100 used by one or more service providers Up, one or more terminals 200 used by one or more service receivers Ue, and the test-driving management device 300.

A store is, for example, a store which sells a vehicle to the service provider Up. The store may be a real shop that actually has a shop or may be an online shop that administrates an online shopping site. A service provider Up is a user of the test-driving system 1 that provides a test-driving vehicle. A service receiver Ue is a user of the test-driving system 1 that performs test-driving. Hereinafter, when the store terminal device 10, the terminal device 100, and the terminal device 200 are not distinguished from each other, the store terminal device 10, the terminal device 100, and the terminal device 200 are simply referred to as “terminal devices.”

These constituent elements can communicate with each other via a network NW. The network NW includes the Internet, a wide area network (WAN), a local area network (LAN), a public communication circuit, a provider device, a dedicated line, and a wireless base station. “Use by a service provider or a service receiver” may include temporary use by a service provider or a service receiver and use of a terminal device in an Internet cafe.

### [Store Terminal Device]

The store terminal device 10 is, for example, a terminal device that is managed by a new vehicle store such as a car dealer. The store terminal device 10 is, for example, a terminal device such as a personal computer, a tablet terminal, or a smartphone. The store terminal device 10 activates an application program, a browser, or the like for using the test-driving system 1 and supports services to be described below. In the following description, it is assumed that the store terminal device 10 is a personal computer and a supervisor of the store uses a browser to use services provided by the test-driving management device 300. For example, the store terminal device 10 transmits a store ID and a password set for each store to the test-driving management device 300. The test-driving management device 300 provides various services to the store terminal device 10 when the store ID and the password match a store ID and a password set in advance.

### [Terminal Device of Service Provider]

The terminal device 100 of the service provider Up is, for example, a terminal device such as a smartphone, a tablet terminal, or a personal computer. The terminal device 100 activates an application program, a browser, or the like for using the test-driving system 1 and supports services to be described below. In the following description, it is assumed that the terminal device 100 is a smartphone and a central processing unit (CPU) of the smartphone executes an application program (a test-driving application 110) and performs each process. The test-driving application 110 communicates with the test-driving management device 300 in response to an operation by the service provider Up and the service provider Up transmits information input to the smartphone to the test-driving management device 300 or performs a push notification based on information received from the test-driving management device 300.

### [Terminal Device of Service Receiver]

The terminal device 200 of the service receiver Ue is, for example, a terminal device such as a smartphone, a tablet terminal, or a personal computer. The terminal device 200 activates an application program, a browser, or the like for using the test-driving system 1 and supports services to be described below. In the following description, it is assumed that the terminal device 200 is a smartphone and a central processing unit (CPU) of the smartphone executes an application program (a test-driving application 210) and performs each process. The test-driving application 210 communicates with the test-driving management device 300 in response to an operation by the service receiver Ue and the service receiver Ue transmits information input to the smartphone to the test-driving management device 300 or performs a push notification based on information received from the test-driving management device 300.

The test-driving application 210 may be similar to the test-driving application 110 or may be a different application program. In the embodiment, for example, the test-driving application 210 is similar to the test-driving application 110, but functions which can be used in accordance with whether a user is the service provider Up or the service receiver Ue are assumed to be different.

### [Test-Driving Management Device]

The test-driving management device 300 includes, for example, a communicator 310, an acquirer 320, an information generator 330, an information manager 340, a reservation manager 350, a recommender 360, an assessor 370, a reward manager 380, and a storage 400.

The acquirer 320, the information generator 330, the information manager 340, the reservation manager 350, the recommender 360, the assessor 370, and the reward manager 380 are realized, for example, by causing a processor such as a CPU to execute a program (software) stored in the storage 400. Some or all of the constituent elements may be realized by hardware (a circuit unit including circuitry) such as a large-scale integration (LSI), an application-specific integrated circuit (ASIC), a field-programmable gate array (FPGA), or a graphics-processing unit (GPU) or may be realized by software and hardware in cooperation. The program may be stored in advance in a storage device such as a hard disk drive (HDD) or a flash memory or may be stored in a storage medium such as a DVD, a CD-ROM which is detachably mounted so that the storage medium is mounted on a drive device and is installed on the storage device. Of these functional units, some functional units may be distributed to another device such as the terminal device 100 or the terminal device 200. Information stored in the storage 400 may also be stored in another storage device.

The storage 400 is realized by an HDD, a flash memory, a random-access memory (RAM), a read-only memory (ROM), or the like. The storage 400 stores, for example, image generation information 402, service provider information 404, service receiver information 406, request information 408, schedule information 410, recommendation information 412, store information 414, assessment information 416, reward management information 418, and the like. The details of the information will be described later.

The communicator 310 is, for example, a network card that is connected to the network NW. The communicator 310 communicates with the store terminal device 10, the terminal device 100, the terminal device 200, and the like via the network NW.

The acquirer 320 acquires information transmitted by the store terminal device 10, the terminal device 100, or the terminal device 200 via the communicator 310 and the network NW. The acquirer 320 includes, for example, a first acquirer 322 and a second acquirer 324. The first acquirer 322 acquires a test-driving request of a user transmitted by the terminal device 200. The test-driving request is information for making a request for test-driving on a vehicle. The second acquirer 324 acquires information (for example, purchase of a vehicle, merchandise, a service, or the like) regarding an action estimated to be performed after a user performs test-driving of a test-driving request.

The information generator 330 generates information regarding an image which a display of a terminal device displays with reference to the image generation information 402. The information generator 330 generates the information regarding the image in response to a request or an operation of the terminal device. The image generation information 402 is, for example, information regarding a service provided to the terminal device by the test-driving management device 300 or information regarding an image displayed on the display of the terminal device.

The information manager 340 stores information transmitted by the terminal device in the storage 400, or reads the information stored in the storage 400 and provides the read information to the terminal device.

The reservation manager 350 includes, for example, a searcher 352 and a manager 354. The searcher 352 selects a vehicle that matches a request of a test-driving request from test-driving vehicles registered in advance. The manager 354 determines whether a provider of the vehicle selected by the searcher 352 responds to the test-driving request. The details of a process of the reservation manager 350 and processes of the recommender 360, the assessor 370, and the reward manager 380 to be described below will be described later.

When a vehicle requested with the test-driving request is not handled by a selling agency (seller) at a time point at which the test-driving request is transmitted or on a scheduled day of test-driving requested in the test-driving request, the recommender 360 transmits, to the terminal device 200, guidance for test-driving on a type of vehicle which is similar to the type of vehicle requested for the test-driving in the test-driving request of the user and is handled by the selling agency.

After the service receiver Ue performs the test-driving on the vehicle, the assessor 370 acquires an assessment regarding the service receiver Ue that performs the test-driving on the vehicle for the test-driving request. The assessor 370 acquires the assessment regarding a provider providing the vehicle for the test-driving request after the user performs the test-driving on the vehicle. Then, the assessor 370 causes the storage 400 to store the acquired information as assessment information 416.

The reward manager 380 sets a reward for the provider of the vehicle based on the information (for example, information indicating purchase of a vehicle or the like) acquired by the acquirer 320 and grants a reward provided by a vehicle selling agency to the provider after the provider responds to the test-driving request or performs the test-driving on the vehicle.

### [Overview]

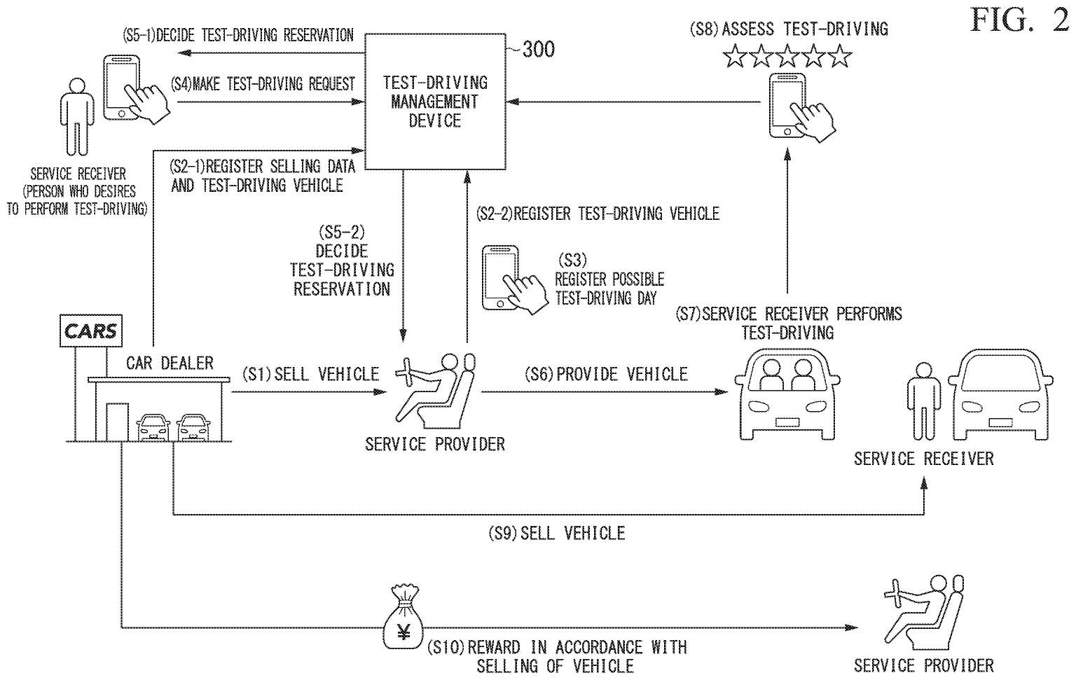

FIG. 2 is a diagram showing an overview of a process in the test-driving system. The details of each process will be described below.

First, a vehicle store sells a vehicle to a customer (step S1). Subsequently, a supervisor of the store obtains an approval of the customer and registers information for using vehicle selling data and a sold vehicle for a test-driving service in the test-driving management device 300 (step S2-1). The test-driving service is a service that provides a vehicle which has been purchased to a person who wishes to perform test-driving as a test-driving vehicle. Thus, the vehicle is registered as a test-driving vehicle. The customer providing the test-driving vehicle is the service provider Up. As described above, since the store manages information regarding the sold vehicle or information regarding an owner, the store can register the test-driving vehicle by proxy instead of the owner of the vehicle. Thus, a burden on registration of the information by the vehicle owner is reduced.

The service provider UP purchasing the vehicle from the store may register the owned vehicle as a test-driving vehicle in the test-driving management device 300 (step S2-2). The service provider Up may be a store. In this case, the test-driving vehicle is a vehicle which is managed by the store. The service provider Up may be a vehicle owner who does not purchase a vehicle from the store. For example, the service provider Up includes a supervisor providing a car sharing service, a person using a vehicle in a service such as delivery by proxy, and a vehicle owner purchasing a vehicle from a seller different from the store and is not particularly limited. In this case, an owner of each vehicle is the service provider Up. The service provider Up may be limited to a person who has a purchase history of vehicles at a predetermined store. When a vehicle used for a car sharing service is used for test-driving, a vehicle at a time at which the car sharing service is not scheduled to be provided is provided as a test-driving vehicle.

Subsequently, the terminal device 100 transmits a possible test-driving day which is a day and time on which the test-driving service can be provided to the test-driving management device 300 based on an operation by the service provider Up for registration (step S3). Subsequently, the terminal device 200 registers a test-driving request including desired test-driving criteria in the test-driving management device 300 based on an operation by the service receiver Ue (step S4).

Subsequently, the test-driving management device 300 searches for a test-driving vehicle that matches the test-driving request, makes a test-driving reservation, and transmits information regarding the test-driving reservation (reservation decision information) to the service provider Up and the service receiver Ue (steps S5-1 and S5-2).

Subsequently, the service provider Up provides a vehicle to the service receiver Ue (step S6) and provides the test-driving service to the service receiver Ue (step S7). When the vehicle is a manual driving vehicle (the vehicle is in which driver manipulates), for example, the service provider Up performs driving and moves to a site in which the test-driving service is provided. When the vehicle is an automated driving vehicle, the vehicle may move to a site in which the test-driving service is provided by automated driving.

Subsequently, the service receiver Ue and the service provider Up perform a mutual assessment of the service receiver Ue and the service provider Up and transmit assessment results to the test-driving management device 300 for registration (step S8). When the service receiver Ue performs the test-driving, the test-driving management device 300 provides a reward for the provision of the test-driving service to the service provider Up (of which the details will be described below). The reward includes money, a commodity, a coupon which can be used in a designated store, or points which can be converted to a privilege such as a discount. The designated store is, for example, a vehicle store in which a new vehicle is sold. The designated store may be a store in which the test-driving vehicle is purchased.

Subsequently, a store (for example, a store in which a test-driving vehicle is sold to the service provider Up) sells the vehicle on which the service receiver Ue performs the test-driving (or a vehicle related to the test-driving vehicle, merchandise related to the test-driving vehicle, or a service related to the test-driving vehicle) (step S9). The test-driving vehicle is, for example, the same type of vehicle as the test-driving vehicle. The vehicle related to the test-driving vehicle is any set vehicle. The vehicle related to the test-driving vehicle is, for example, a vehicle sold in a store. The merchandise is, for example, a component (a tire, a battery, or the like) of a vehicle sold in a store. The service is an inspection service, a car washing service, or the like. Hereinafter, the vehicle, the merchandise, or the service is referred to as a “selling target.” Subsequently, the service provider Up receives the reward for selling of the vehicle from the store (step S10).

In this way, in the test-driving on the vehicle, the service receiver Ue can perform the test-driving on a vehicle of interest to the service receiver Ue, a seller of the vehicle can promote vehicle selling, and the service provider Up can receive a reward for the provision of the service.

In the foregoing process, the store can reduce the number of vehicles for the test-driving service or can reduce a process load on the test-driving. The service provider Up can acquire rewards, can make the owned vehicle appeal to the service receiver Ue, or can expand transaction relationships. The service receiver Ue can easily perform the test-driving on a vehicle on which the service receiver Ue desires to perform the test-driving. The service receiver Ue can hear information regarding the vehicle from the service provider Up who actually owns the vehicle or can receive preferential treatment at the time of purchase of a vehicle.

When a vehicle of a car sharing service is used for the test-driving, a user who uses the vehicle may use both the car sharing service and the test-driving service. In this case, costs incurred in moving to a destination (or costs for the usage time) can be set to be reduced for the service receiver Ue.

### [Registration and Test-Driving Reservation of Service Provider (Part 1)]

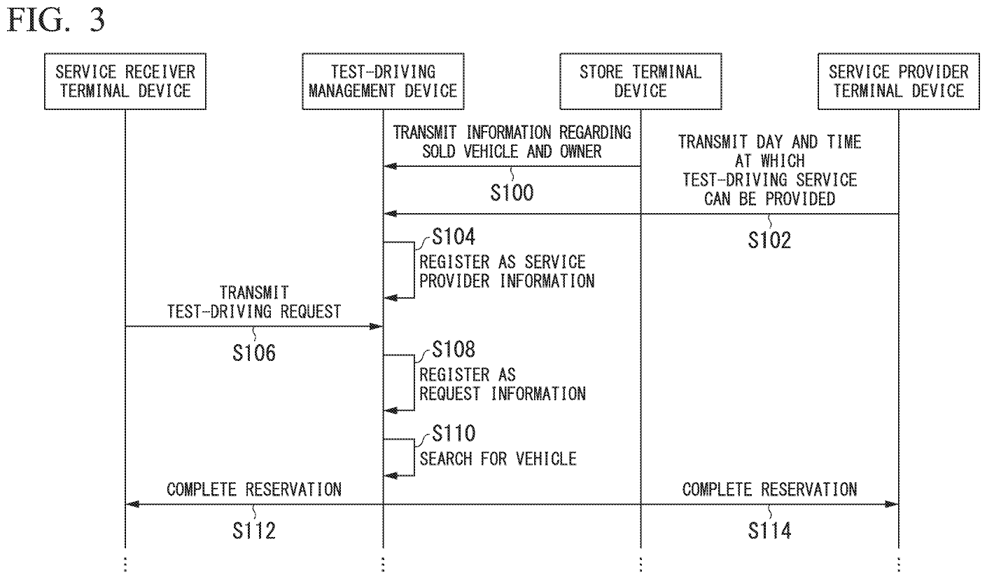

FIG. 3 is a sequence diagram showing a flow of a process related to registration and a test-driving reservation of a service provider. First, the store terminal device 10 transmits information regarding the sold vehicle and the owner of the vehicle to the test-driving management device 300 based on an operation by an attendant of the store (step S100). At this time, the attendant obtains an approval from the owner who purchases the vehicle.

Subsequently, the terminal device 200 transmits a day and time at which the test-driving service can be provided to the test-driving management device 300 based on an operation by the service provider Up (step S102). The information manager 340 of the test-driving management device 300 stores the information transmitted by the store terminal device 10 and the terminal device 100 as service provider information 404 in the storage 400 (step S104).

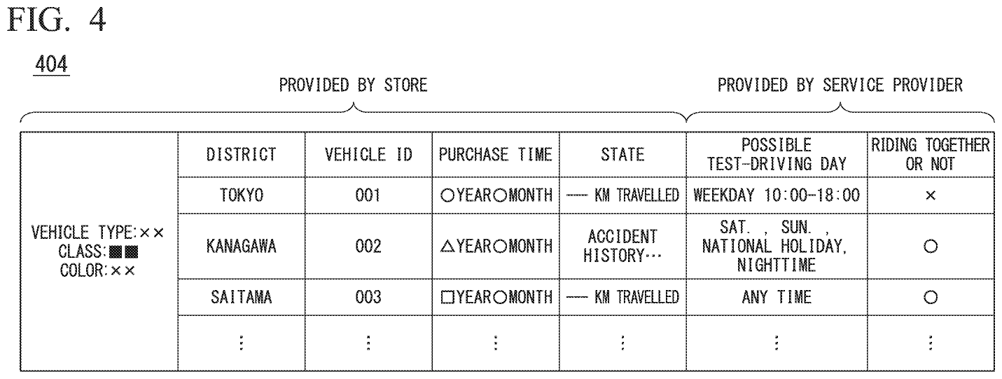

FIG. 4 is a diagram showing an example of content of the service provider information 404. The service provider information 404 is, for example, information in which a type of vehicle (for example, a vehicle type, a class, a color, a model, and the like), a district in which the test-driving service can be provided, a vehicle ID, a vehicle purchase time, a vehicle state (for example, a travel distance, an accident history, and the like), a possible test-driving day and time, and information indicating whether a vehicle owner rides together at the time of test-driving are associated with each other. In the service provider information 404, the type of vehicle, the district in which the test-driving service can be provided, the vehicle ID, the vehicle purchase time, and the vehicle state are, for example, information provided by the store terminal device 10. The possible test-driving day and time and the information indicating whether a vehicle owner rides together are, for example, information provided by the terminal device 100 of the service provider Up. The district may be a district in accordance with a position derived based on positional information transmitted in real time by the vehicle. The service provider information 404 may include attributes or the like of the service provider. The storage 400 stores the service receiver information 406. The service receiver information 406 includes information such as identification information of the service receiver Ue, an attribute, a past use history of the test-driving service, and a selling target purchased in the store.

FIG. 3 is referred to back for description. Subsequently, the terminal device 200 transmits a test-driving request to the test-driving management device 300 based on an operation by the service receiver Ue (step S106). The store terminal device 10 of the store or another device may transmit a test-driving request of the service receiver Ue to the test-driving management device 300 based on an operation by the service receiver Ue, an attendant of the store, or the like. Subsequently, the information manager 340 of the test-driving management device 300 causes the storage 400 to store the acquired test-driving request as the request information 408 (step S108).

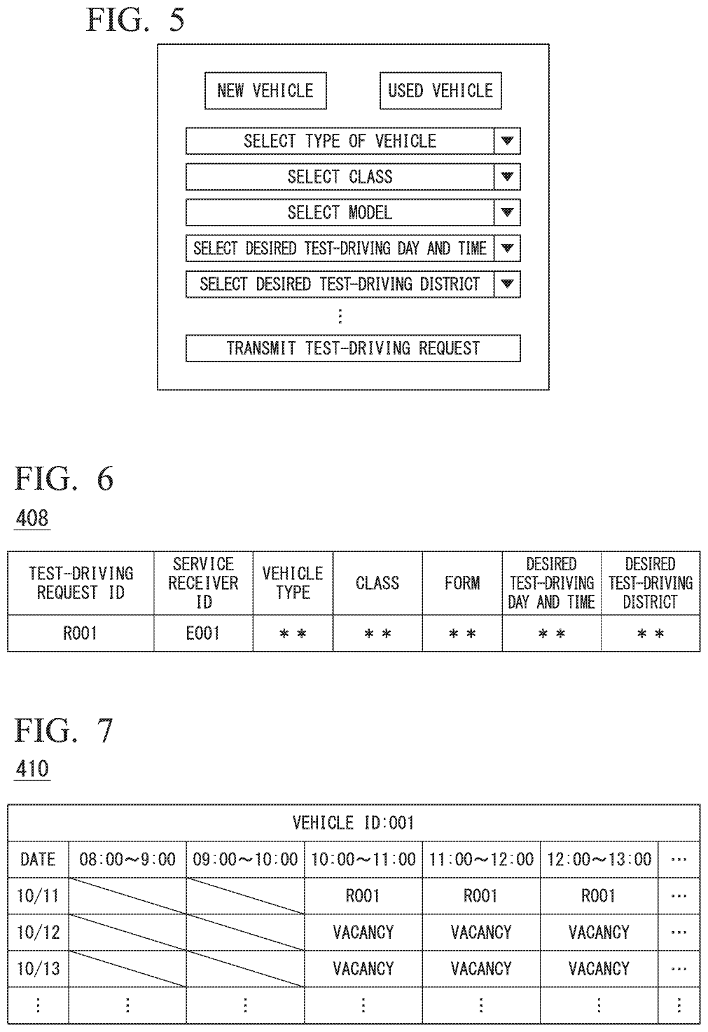

FIG. 5 is a diagram showing an example of an input screen of a test-driving request. For example, the service receiver Ue inputs information regarding a vehicle on which the service receiver Ue desires to perform the test-driving by operating an input screen displayed on the display of the terminal device 200, as shown in FIG. 5. When a transmission button is operated after the input, the test-driving request including an input result is transmitted to the test-driving management device 300. The information regarding the vehicle applied for the test-driving is a new vehicle or a used vehicle, a vehicle type, a class, a model, a desired test-driving day and time, a desired test-driving district, and the like.

FIG. 6 is a diagram showing an example of content of the request information 408. The request information 408 is information in which a test-driving request ID, a service receiver ID, a vehicle type, a class, a model, a desired test-driving day and time, and a desired test-driving district are associated with each other.

After the process of step S108 of FIG. 3, the searcher 352 of the test-driving management device 300 searches for a vehicle in accordance with the test-driving request (step S110). Then, when the manager 354 determines that the vehicle that matches the test-driving request is prepared, the manager 354 transmits information indicating completion of a reservation to the terminal device 200 of the service receiver Ue and the terminal device 100 of the service provider Up (steps S112 and S114). For example, the manager 354 compares the service provider information 404 registered by the owner (the service provider Up) of the vehicle that matches the test-driving request with a request included in the test-driving request. When the manager 354 determines that the service provider Up can respond to the test-driving request (can provide the test-driving service), the manager 354 determines that the vehicle can be prepared. For example, when the vehicle requested with the test-driving request is owned and a time at which the test-driving in the test-driving request is desired for is included in a time at which the test-driving service registered by the service provider Up can be provided, the manager 354 determines that the service provider can respond to the test-driving request.

When the vehicle can be prepared, the manager 354 of the test-driving management device 300 associates a schedule of the test-driving request with the schedule information 410 of the service provider Up. FIG. 7 is a diagram showing an example of content of the schedule information 410. The schedule information 410 is, for example, information including a day and time at which the test-driving service can be provided for each vehicle ID (or each service provider Up) or a reservation day and time of the test-driving service. The information is information generated based on information provided by the service provider Up.

As described above, the test-driving management device 300 manages the information regarding the service provider Up, searches for a vehicle that matches the test-driving request, and establishes the reservation when the vehicle that matches the request can be searched. Thus, the service provider Up can perform a procedure for easily providing the test-driving service and the service receiver Ue can easily make a reservation for the test-driving service.

### [Test-Driving Reservation (Part 2)]

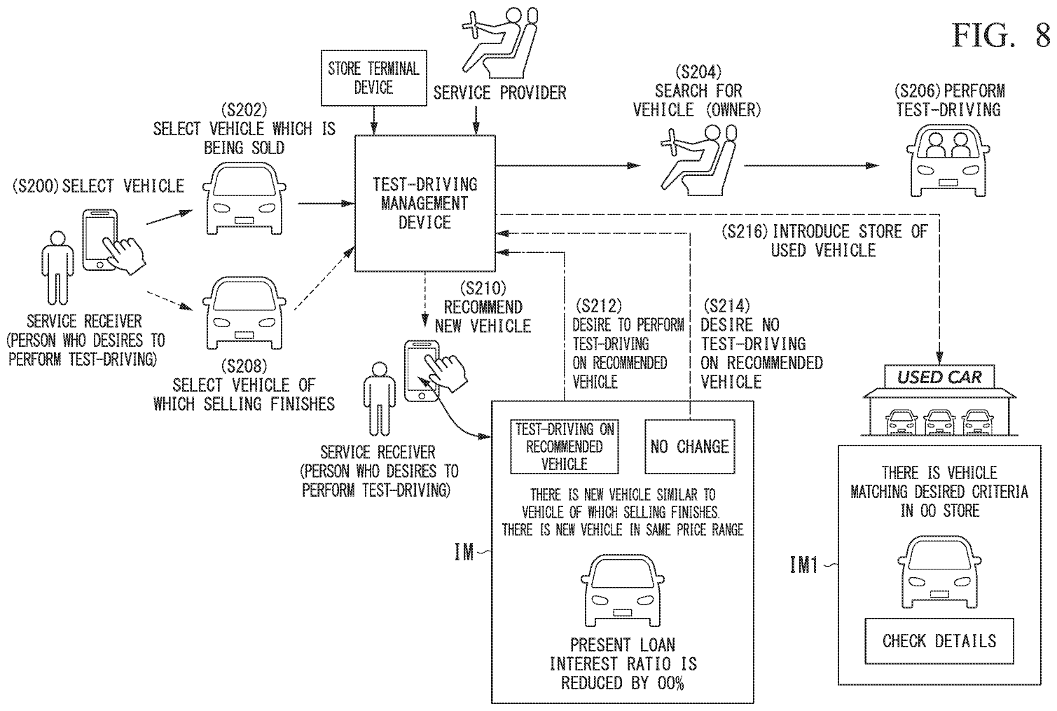

FIG. 8 is a diagram showing another flow of the process related to a test-driving reservation. When the terminal device 200 transmits the test-driving request of a vehicle which is sold to the test-driving management device 300 based on an operation by the service receiver Ue (steps S200 and S202), the reservation manager 350 of the test-driving management device 300 searches for a vehicle that matches the test-driving request and makes a reservation for the test-driving based on a searching result as in the process of FIG. 3 described above (step S204). Then, the service receiver Ue performs the test-driving (step S206).

When the terminal device 200 transmits a test-driving request for a vehicle of which selling finishes to the test-driving management device 300 based on an operation by the service receiver Ue (steps S200 and S208), a process different from the above-described process of FIG. 3 is performed. In this case, the recommender 360 of the test-driving management device 300 selects a recommended vehicle based on the test-driving request of the service receiver Ue with reference to the recommendation information 412 and recommends the selected vehicle (step S210).

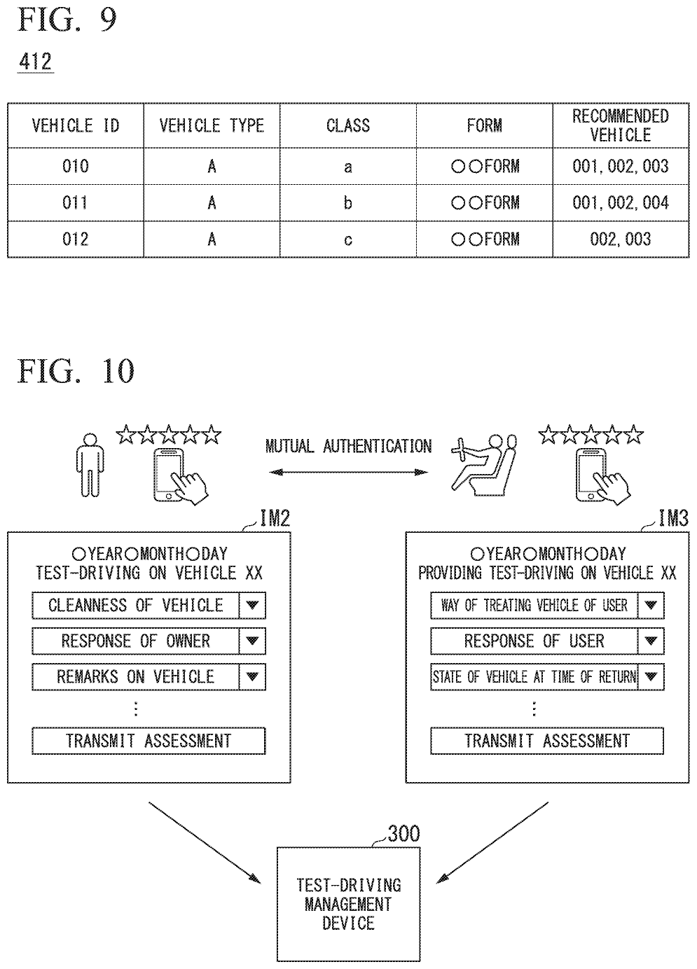

FIG. 9 is a diagram showing an example of content of the recommendation information 412. The recommendation information 412 is, for example, information in which a vehicle ID and a recommended vehicle associated with a vehicle type, a class, a model, and a price range included in the test-driving request are associated with each other. The recommended vehicle is a vehicle estimated to interest the service receiver Ue selecting the vehicle of which selling finishes in the test-driving request (which is an example of a “similar type of vehicle”). The vehicle of interest is, for example, a similar type of vehicle, model, or price range.

For example, the test-driving management device 300 provides information regarding the recommended vehicle to the terminal device 200. An image including the information regarding the recommended vehicle is displayed on the display of the terminal device 200, as shown in an image IM of FIG. 8 described above. For example, in the image IM, information regarding the vehicle which is being sold and interests the service receiver Ue is included as information regarding the recommended vehicle.

Subsequently, when the service receiver Ue selects the test-driving on the recommended vehicle on which the service receiver Ue desires to perform the test-driving, the terminal device 200 transmits information indicating the selection to the test-driving management device 300 (step S212). Subsequently, with reference to the service provider information 404 and the schedule information 410, the reservation manager 350 of the test-driving management device 300 searches for the vehicle on which the service receiver Ue desires to perform the test-driving and makes a reservation for the test-driving on the vehicle based on a searching result (step S204). Then, the service receiver Ue performs the test-driving on the recommended vehicle (step S206).

The recommendation 360 determines a vehicle for which there is a vacancy in a schedule at the desired test-driving day and time of the test-driving request as a preferentially recommended vehicle and recommends the determined vehicle for the service receiver Ue.

Subsequently, when the service receiver Ue does not select the test-driving on the recommended vehicle (when the user does not approve of the test-driving on the similar type of moving object), the terminal device 200 transmits information regarding the non-selection to the test-driving management device 300 (step S214). Subsequently, the reservation manager 350 of the test-driving management device 300 searches for a vehicle associated with the test-driving request with reference to the store information 414 and provides information regarding the store in which a vehicle requested with the test-driving request which is a searching result is sold, to the service receiver Ue (step S216). The store information 414 includes information regarding the store in which the vehicle of which selling finishes is treated and the vehicle which is sold in the store. The display of the terminal device 200 displays an image including the information regarding the store in which the vehicle of which selling finishes is handled, as shown in the image IM1 of FIG. 8 described above.

In this way, the test-driving management device 300 can promote vehicle selling by providing the test-driving service of the vehicle matching the preferences of the service receiver Ue.

[Assessment after Test-Driving]

After the service receiver Ue performs the test-driving on the vehicle and the service provider Up provides the test-driving service, an assessment is mutually performed.

After the test-driving ends (when information indicating end of the test-driving is acquired from the test terminal 100 or the terminal device 200), the test-driving management device 300 transmits a mutual assessment image to the terminal device 100 and the terminal device 200. FIG. 10 is a diagram showing an example of a mutual authentication image. An image IM2 is an image displayed on the display of the terminal device 200 and an image IM3 is an image displayed on the display of the terminal device 100. The image IM2 is an image for inputting an assessment of the service provider Up. The image IM2 is, for example, an image for inputting an assessment of assessment items such as cleanness of the vehicle, a response of the owner of the vehicle, and remarks on the vehicle of the owner riding together. In the assessment of the remarks on the vehicle of the owner riding together, remarks or non-remarks on the vehicle, the degree of remarks, the degree of recommendation to purchase the vehicle excessively, and the like are added. In the assessment items, an item for assessing whether the remarks on the vehicle is appropriately received is provided from the owner and a weight of the assessment of the item may be set to be higher than a weight of other assessments. This is because the remarks of the owner have a considerable influence on selling of the vehicle.

The image IM3 is an image for inputting an assessment for the service receiver Ue. The image IM3 is, for example, an image for inputting an assessment of assessment items such as a way of treating the vehicle of the service receiver Ue, a response of the service receiver Ue, and a vehicle state at the time of returning of the vehicle.

Information input by the service receiver Ue and the service provider Up is transmitted to the test-driving management device 300 and is stored as assessment information 416 in the storage 400.

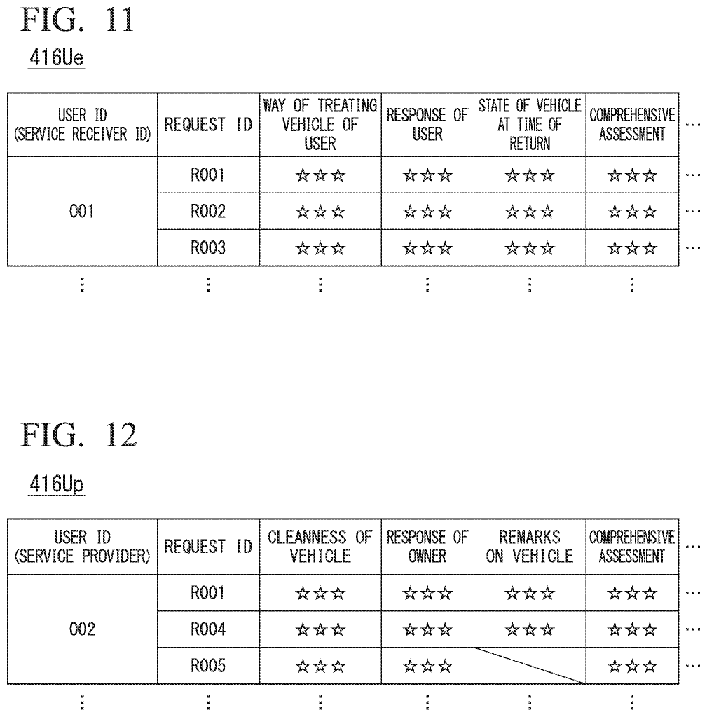

FIG. 11 is a diagram showing an example of content of assessment information 416Ue of the service receiver Ue. The assessment information 416Ue is information in which a user ID, a request ID, assessment items, and a comprehensive assessment in the test-driving are associated with each other.

FIG. 12 is a diagram showing an example of content of assessment information 416Up of the service provider Up. The assessment information 416Up is information in which a user ID, a request ID, assessment items, and a comprehensive assessment in the test-driving are associated with each other.

A process for the foregoing assessment (for example, a process related to the assessment of the service provider Up) may be performed only when the service provider Up rides together in the test-driving of the service receiver Ue. For example, the terminal device 200 transmits information indicating whether the owner of the vehicle rides together to the test-driving management device 300 based on an operation by the service receiver Ue. Thus, the test-driving management device 300 can recognize that the owner of the vehicle rides together at the time of test-driving.

For example, the reservation manager 350 may provide the information regarding the assessment of the service receiver Ue transmitting the test-driving request to the service provider Up providing the test-driving service. In this case, the service provider Up may determine whether the test-driving service is provided based on the assessment of the service receiver Ue. The reservation manager 350 may limit a service to be provided to the service receiver Ue when the assessment is equal to or less than a threshold. For example, the reservation manager 350 may reject the reservation for the test-driving service for the service receiver Ue of which an assessment is equal to or less than the threshold during a predetermined period or may limit a test-driving time, a test-driving distance, or a test-driving area than that of the service receiver Ue of which the assessment exceeds the threshold.

For example, the reservation manager 350 may provide information regarding the assessment of the service provider Up having received the test-driving request to the service receiver Ue having transmitted the test-driving request. In this case, the service receiver Ue may determine whether to use the test-driving service based on the assessment of the service provider Up.

### [Providing Reward]

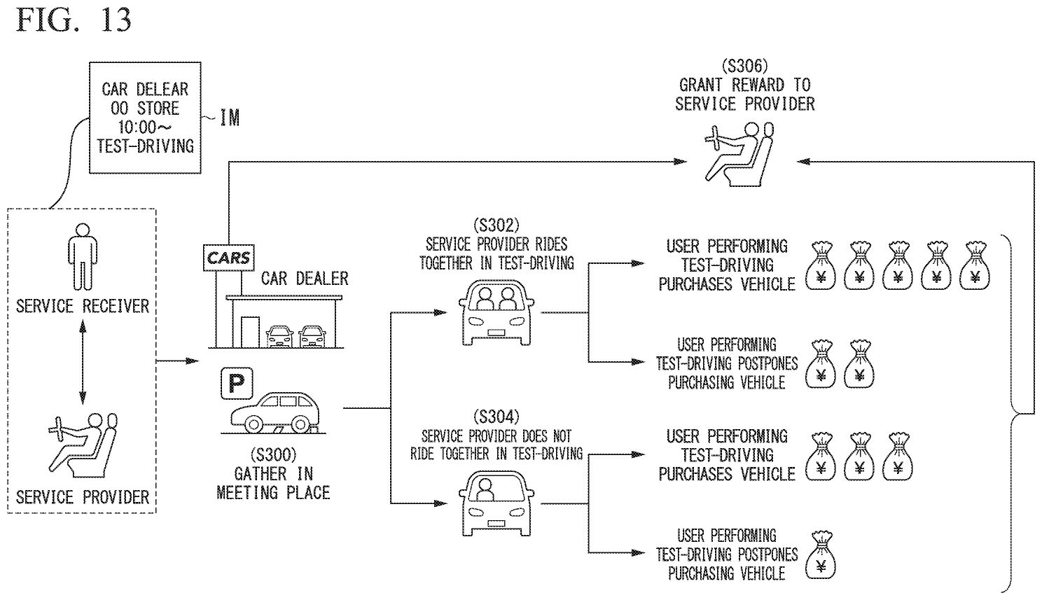

When the service receiver Ue performing the test-driving purchases the selling target, the test-driving management device 300 grants a reward to the service provider Up having provided the test-driving service. FIG. 13 is a diagram showing a flow of a process of providing a reward. Hereinafter, a process after the reservation for the test-driving will be described.

First, the service provider Up and the service receiver Ue gather in a meeting place (step S300). A process when the service provider Up rides together with the service receiver Ue in the test-driving (step S302) will be described. When the service receiver Ue purchases the selling target (for example, a vehicle) after the test-driving, the test-driving management device 300 grants a reward of a first degree to the service provider Up (step S306). When the service receiver Ue does not purchase the selling target after the test-driving, the test-driving management device 300 grants a reward of a second degree (<the first degree) to the service provider Up (step S306).

A process when the service provider Up does not ride together with the service receiver Ue in the test-driving (step S304) will be described. When the service receiver Ue purchases the selling target after the test-driving, the test-driving management device 300 grants a reward of a third degree (<the first degree/>the second degree) to the service provider Up (step S306). When the service receiver Ue does not purchase the selling target after the test-driving, the test-driving management device 300 grants a reward of a fourth degree (<the second degree) to the service provider Up (step S306). The rewards are, for example, rewards which are provided by the store selling the selling target to the service receiver Ue. The above-described assessment may be reflected in the rewards. For example, a reward higher than a reward of the service provider Up of which the assessment is lower may be granted to the service provider Up of which the assessment is higher.

As described above, when the service provider Up rides together in the test-driving, it is expected that the service provider Up provides charm of the vehicle to the service receiver Ue and selling of the vehicle is promoted. Therefore, when the service provider Up rides together in the test-driving, the reward is set to be higher than when the service provider Up does not ride together in the test-driving.

### [Sequence]

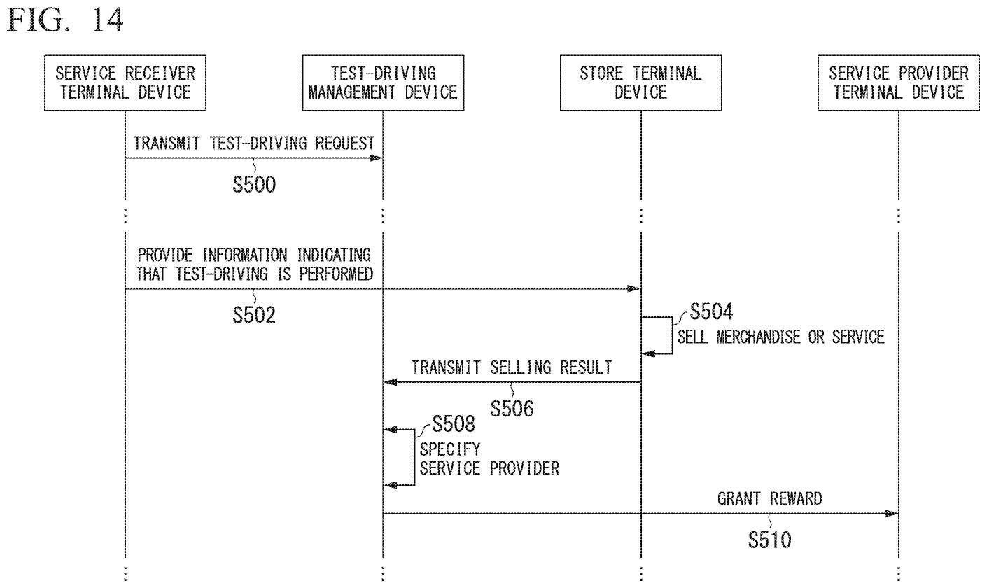

FIG. 14 is a sequence diagram showing an example of a flow of a process performed by the test-driving system 1. First, the terminal device 200 transmits a test-driving request to the test-driving management device 300 (step S500). Then, the test-driving management device 300 makes a reservation for the test-driving service as described above with reference to FIG. 2 or 3. Thereafter, the service receiver Ue is assumed to perform the test-driving on the vehicle provided by the service provider Up.

After the service receiver Ue performs the test-driving, the terminal device 200 transmits information indicating that the service receiver Ue performs the test-driving to the test-driving management device 300 based on an operation by the service receiver Ue (step S502). Thereafter, the service receiver Ue is assumed to purchase the same type of vehicle as the vehicle on which the service receiver Ue performs the test-driving in the store. At this time, the service receiver Ue delivers the fact that the test-driving service is used to an attendant of the store. For example, the service receiver Ue activates the test-driving application 210, causes the display of the terminal device 200 to display the information and present the information to the attendant of the store (step S504). The information notes that the service receiver Ue used the test-driving service. The information is provided by the test-driving management device 300.

The attendant of the store operates the store terminal device 10 to input information indicating that the service receiver Ue purchases the vehicle (including identification information of the selling target) and information indicating that the service receiver Ue is the service receiver Ue using the test-driving service (for example, the test-driving request ID at the time of use) and transmits the input information to the test-driving management device 300 (step S506). The terminal device 200 may transmit purchase information indicating that the selling target is purchased to the test-driving management device 300. In this case, for example, the terminal device 200 transmits information in which an ID issued by the store and the information indicating that a purchase target is purchased are associated to the test-driving management device 300.

Subsequently, the reward manager 380 of the test-driving management device 300 acquires the information transmitted by the store terminal device 10 and specifies the service provider Up providing the test-driving service to the service receiver Ue based on the acquired information (step S508). For example, with reference to the schedule information 410 or the like, the test-driving management device 300 specifies the service provider Up based on the test-driving request ID.

Subsequently, the test-driving management device 300 grants the reward based on the vehicle (the purchase target) purchased by the service receiver Ue to the terminal device 200 of the service provider Up for the specified service provider Up (step S510). The kind or degree of the reward is set for each type of merchandise, each type of service, and each type of vehicle purchased by the service receiver Ue. For example, a reward for the purchase of the vehicle is greater than a reward for purchase of a component or a service. Only when the service receiver Ue visits a predetermined store, a reward in accordance with the visit may be granted to the service provider Up.

### [Management of Reward]

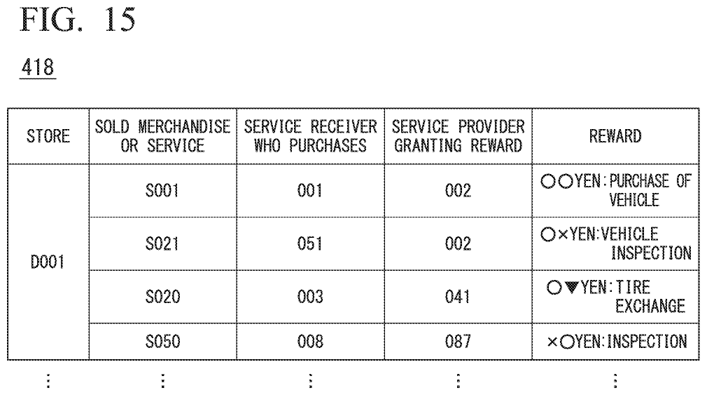

For example, the test-driving management device 300 manages rewards using the reward management information 418. FIG. 15 is a diagram showing an example of content of the reward management information 418. The reward management information 418 is information indicating a list of rewards granted to the service provider Up in each store. For example, the reward management information 418 is information in which the service receiver Ue purchasing a selling target which is sold to the service receiver Ue in the store, the service provider Up providing the test-driving service, and a reward granted to the service provider UP are associated with each other. For example, the test-driving management device 300 may collect rewards granted to each service provider Up during a predetermined period with reference to the reward management information 418 and may grant a reward to the service provider Up based on a collection result.

In this way, by granting the reward to the service provider Up providing the test-driving service, it is possible to enhance the motivation of the service provider Up providing the test-driving service.

When the service receiver Ue using the test-driving service purchases a vehicle or the like in the store, a privilege may be granted to the service receiver Ue. The privilege is granting of a service for discount or an accessory or a service such as free inspection, or the like. In this case, the test-driving management device 300 specifies the service receiver Ue manifesting an intention to purchase a selling target based on information transmitted by the terminal device and grants a privilege of purchasing the selling target when the specified user is identical to the service receiver Ue receiving the test-driving service and stored in the storage 400. For example, the test-driving management device 300 transmits a coupon with which a predetermined discount can be received to the terminal device 100.

Based on an assessment of the service receiver Ue, a privilege may be granted. For example, a privilege is granted so that the service receiver Ue is further preferred as the assessment is higher. In this case, it is possible to enhance the motivation of the service receiver Ue to use the test-driving service.

In this way, the service provider Up and the service receiver Ue actively use the test-driving service, and thus it is possible to promote vehicle selling.

The test-driving management device 300 may specify a first user using the test-driving service and purchasing a vehicle and a second user purchasing the vehicle without using the test-driving service with reference to information stored in the storage 400 and may give preference to a reward granted to the first user when a vehicle registered for the test-driving in the test-driving service is used for the test-driving service by the first user to a reward granted to the second user when a vehicle registered for the test-driving in the test-driving service is used for the test-driving service by the second user (for example, may set the reward granted to the first user to be greater than the reward granted to the second user).

According to the above-described first embodiment, the test-driving management device 300 utilizes the test-driving of the vehicle by selecting a vehicle that matches the test-driving request of the user, determining whether the provider of the selected vehicle responds to the test-driving request, and allowing a vehicle selling agency to grant a reward for the service provider Up after the service provider Up responds to the test-driving request or the test-driving on the vehicle is performed, and thus it is possible to improve convenience for a seller, a purchaser, or a user of the vehicle.

### Second Embodiment

Hereinafter, a second embodiment will be described. In the first embodiment, the test-driving management device 300 has made a reservation for the test-driving service based on a day on which the test-driving service registered in advance by the service provider Up can be provided. In the second embodiment, however, the test-driving management device 300 searches for the service provider Up who can provide the test-driving service in real time and makes a reservation of the test-driving service based on a searching result. Hereinafter, differences from the first embodiment will be described.

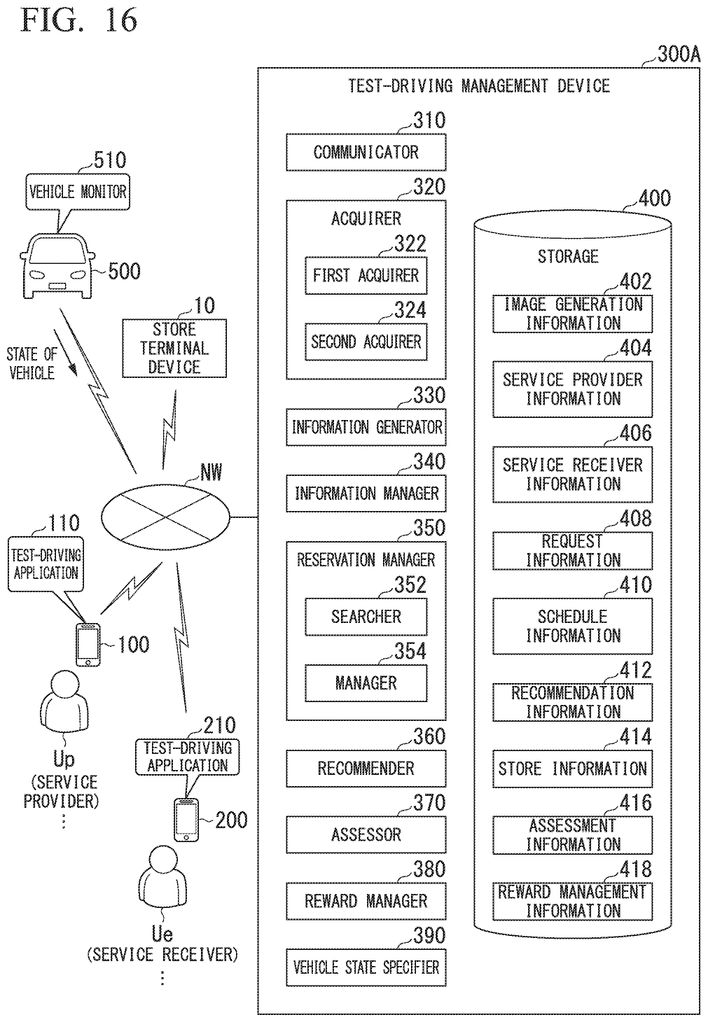

FIG. 16 is a diagram showing an example of a configuration of a test-driving system 1A according to the second embodiment. The test-driving system 1A includes a vehicle 500 in addition to the configuration of the test-driving system 1 according to the first embodiment. The vehicle 500 is a vehicle that is registered so that the service provider Up provides a test-driving service. The test-driving system 1A includes a test-driving management device 300A instead of the test-driving management device 300.

The vehicle 500 includes, for example, a communication device, a navigation device, a driving force output device, a brake device, a steering device, and a vehicle monitor 510. The vehicle monitor 510 monitors a state or a position of a vehicle. The state of the vehicle is information for estimating a use state of the vehicle such as whether a vehicle is in a traveling state or in a stopping state. The vehicle monitor 510 transmits a monitoring result and positional information of the vehicle for each predetermined time to the test-driving management device 300A by using the communication device.

The test-driving management device 300 further includes a vehicle state specifier 390 in addition to the functional configuration of the test-driving management device 300. The acquirer 320 of the test-driving management device 300A acquires the state of the vehicle and the positional information transmitted by the vehicle 500. The vehicle state specifier 390 estimates whether the vehicle is in a using state based on the state of the vehicle or the positional information of the vehicle acquired by the acquirer 320. For example, when the vehicle stops for a predetermined time or more, the vehicle state specifier 390 estimates that the vehicle is not in the using state and there is a possibility of being used for the test-driving service.

### [Sequence]

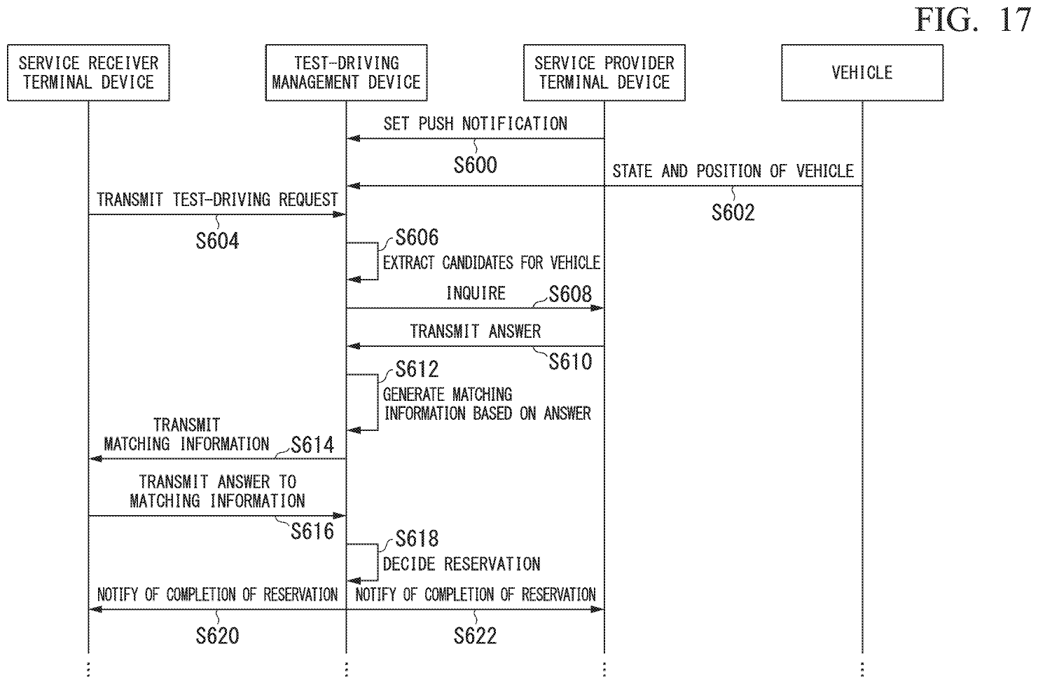

FIG. 17 is a sequence diagram showing a flow of a process performed by the test-driving system 1A according to the second embodiment. First, the terminal device 100 sets a push notification of information regarding real-time matching based on an operation by the service provider Up in the test-driving management device 300A (step S600). Subsequently, the test-driving management device 300A acquires the state and the position of the vehicle from the vehicle 500 (step S602). Subsequently, the terminal device 200 transmits the test-driving request to the test-driving management device 300A based on an operation by the service receiver Ue (step S604).

Subsequently, the reservation manager 350 of the test-driving management device 300A extracts candidates for a vehicle and the service provider Up (step S606). For example, the reservation manager 350 extracts the candidates for the vehicle used for the test-driving service. The candidates for the vehicle are vehicles which are not used at present and are near a desired test-driving district of the test-driving request. The reservation manager 350 may extract candidates for the provider of the test-driving service with reference to the service provider information 404. A candidate for the provider is the service provider Up that provides the test-driving service in a district matching the desired test-driving district included in the test-driving request.

Subsequently, the reservation manager 350 inquires of the terminal device 100 of the service provider Up (or the service provider Up of the candidate) of the vehicle of the extracted candidate about whether the test-driving service that matches the test-driving request can be provided (step S608).

When the test-driving service is provided in the present process (real-time matching process), a reward granted to the service provider Up may be greater than when the test-driving service is provided based on the schedule information 410 registered in advance. In the inquiry, it may be clarified that the reward is greater than when the test-driving service is provided based on the schedule information 410 registered in advance.

Subsequently, the terminal device 200 transmits an answer to the inquiry to the test-driving management device 300A based on an operation by the service provider Up (step S610). In the present process, the terminal device 200 is assumed to transmit the fact that the test-driving service that matches criteria of the test-driving request can be provided to the test-driving management device 300A.

Subsequently, the reservation manager 350 generates matching information regarding the test-driving request based on the answer transmitted by the terminal device 200 (step S612) and transmits the generated matching information to the terminal device 200 (step S614). The matching information is information indicating that the service provider Up that matches the criteria of the test-driving request is extracted and a reservation can be made.

Subsequently, the terminal device 200 transmits the answer to the matching information to the test-driving management device 300A based on an operation by the service receiver Ue (step S616). In the present process, an answer given to make a reservation to the test-driving request is assumed to be transmitted to the test-driving management device 300A by the service receiver Ue.

Subsequently, the reservation manager 350 acquires the answer transmitted by the terminal device 200, generates the schedule information 410 based on an acquisition result and the test-driving request, and decides the reservation (step S618). Subsequently, the test-driving management device 300A transmits information indicating completion of the reservation to the terminal devices 100 and 200 (steps S620 and S622). Then, the service receiver Ue and the service provider Up meet in a predetermined place and the service receiver Ue performs the test-driving on the vehicle of the service provider Up.

In this way, the test-driving management device 300A can search for the service provider Up matching the test-driving request in real time in response to the test-driving request and can provide the test-driving service to the service receiver Ue based on a searching result.

The reservation manager 350 may recommend the test-driving on a specific vehicle to the service receiver Ue based on the state and the position of the vehicle. The specific vehicle is a vehicle which is not used at present and is near a desired test-driving district of the test-driving request. For example, when it is determined based on information indicating permission of the service provider Up of a specific vehicle that the specific vehicle may be used for the test-driving service (when it is determined that the vehicle is a moving object on which the test-driving is possible), the reservation manager 350 may notify the terminal device 200 of the service receiver Ue of recommendation of the test-driving on the specific vehicle. The service receiver Ue is the service receiver Ue that has an authority to transmit the test-driving request. For example, when the fact that the test-driving is possible is registered in the schedule information 410 or when an answer to permission is obtained, the reservation manager 350 determines that the specific vehicle may be used for the test-driving service. Thus, it is possible to prompt the vehicle that is not used to be used for the test-driving service.

When the service receiver Ue gets on a vehicle on which the service provider Up does not ride together, and the service receiver Ue performs the test-driving beyond a set distance set in advance or a set time set in advance based on information acquired from the vehicle 500 or performs the test-driving beyond a predetermined area, the test-driving management device 300A may notify the service receiver Ue or the service provider Up that the service receiver Ue performs the test-driving beyond the set distance or the set time or an area other than the set area.

The service receiver Ue may open a door of a vehicle used for the test-driving service using a virtual key or operate the vehicle. In this case, for example, the test-driving management device 300A transmits predetermined information to the terminal device 200 and transmits key information to the vehicle 500. Then, the test-driving application 210 of the terminal device 200 transmits the generated key information to the vehicle 500 based on the predetermined information. The vehicle 500 combines the key information acquired from the terminal device 200 and the key information acquired from the test-driving management device 300A and opens the door or performs an operation when the key information is identical to each other.

According to the above-described second embodiment, the test-driving management device 300A can determine whether the test-driving is possible in real time by determining whether the vehicle can be used for the test-driving in response to the test-driving request based on the state information indicating a current state of the test-driving vehicle registered in advance and notifying the terminal device of the provider of the vehicle determined to be usable for the test-driving that permission of the test-driving is prompted, and thus it is possible to respond promptly to the test-driving request and guarantee the number of types of vehicles on which the test-driving is possible.

### Third Embodiment

Hereinafter, a third embodiment will be described. In the third embodiment, a process in which the process of making a reservation for the test-driving service in the first embodiment and the process of making a reservation for the test-driving service in the second embodiment are integrated is performed. Hereinafter, differences from the first and second embodiments will be described.

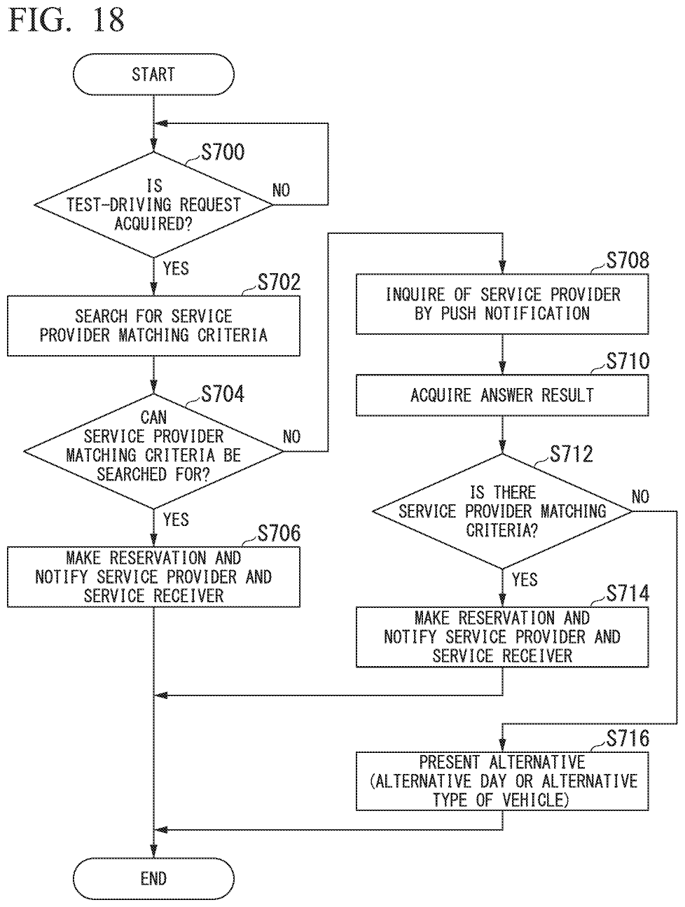

FIG. 18 is a flowchart showing an example of a flow of a process performed by a test-driving management device 300 according to the third embodiment. First, the test-driving management device 300 determines whether the test-driving request is acquired (step S700). When the test-driving request is acquired, the test-driving management device 300 searches for the service provider Up matching the test-driving request with reference to the schedule information 410 or the like stored in the storage 400 (step S702). Subsequently, the test-driving management device 300 determines whether the service provider Up matching criteria of the test-driving request can be searched for (step S704).

When the service provider Up matching the criteria can be searched for, the test-driving management device 300 makes a reservation in response to the test-driving request with reference to the schedule information 410 and notifies the service provider Up and the service receiver Ue of information indicating completion of the reservation (step S706). The process related to step S706 is equal to the process related to the test-driving request described in FIG. 3 or the like of the first embodiment.

When the service provider Up matching the criteria may not be searched for, the test-driving management device 300 extracts a vehicle estimated to be able to provide the test-driving service as a candidate for the vehicle and inquiries whether the service provider Up of the extracted vehicle can provide the test-driving service that matches the criteria of the test-driving request (step S708). Subsequently, the test-driving management device 300 acquires an answer to the inquiry transmitted by the terminal device 200 based on an operation by the service provider Up (step S710).

Subsequently, the test-driving management device 300 determines whether there is the service provider Up matching the criteria (step S712). When there is the service provider Up matching the criteria, the test-driving management device 300 makes a reservation and notifies the service provider Up and the service receiver Ue of completion of the reservation (step S714). The processes of steps S708 to S714 are the same processes as the processes of steps S608 to S622 of FIG. 16 in the second embodiment.

When there is no service provider Up matching the criteria, the test-driving management device 300 transmits an alternative to the terminal device 100 of the service receiver Ue having transmitted the test-driving request (step S716). The alternative is a proposal of the test-driving service that does not match the criteria of the test-driving request and matches predetermined criteria. The predetermined criteria are criteria in which the criteria of the test-driving request are alleviated. The alternative matching the predetermined criteria is, for example, a proposal for proposing a vehicle having a vehicle type or a class, a vehicle type or a class similar to a model, or a model of the test-driving request as the test-driving service, a proposal of the test-driving service for proposing a day and time close to a desired day and time of the test-driving request, or the like. Then, the process of one routine of the flowchart ends.

Through the above-described process, even when there is no vehicle that can provide the test-driving service in the registered schedule information 410, the test-driving management device 300 extract the service provider Up that can provide the test-driving service, can provide the test-driving service in response to the test-driving request to.

According to the above-described third embodiment, the test-driving management device 300 can obtain the advantages of the first and second embodiments and further prepare for the test-driving of the vehicle in response to the test-driving request.

### Fourth Embodiment

Hereinafter, a fourth embodiment will be described. In the fourth embodiment, the reward manager 380 decides the magnitude of a reward granted to the service provider Up or decides the magnitude of a reward granted to the service receiver Ue having transmitted the test-driving request in consideration of balance between a request and provision of the test-driving. Hereinafter, differences from the first embodiment will be described.

The reward manager 380 determines the magnitude of the reward granted to the service provider Up or determines the magnitude of the reward granted to the service receiver Ue having transmitted the test-driving request based on the test-driving request or the extent of vehicles (for example, the number of vehicles) capable of providing the test-driving service.

Based on the magnitude of the reward determined by the reward manager 380 and map information included in the image generation information 402, the information generator 330 generates first reward distribution information indicating the degree of reward granted to the service provider Ue when the test-driving service is used in each district and transmits the generated first reward distribution information to the terminal device 200.

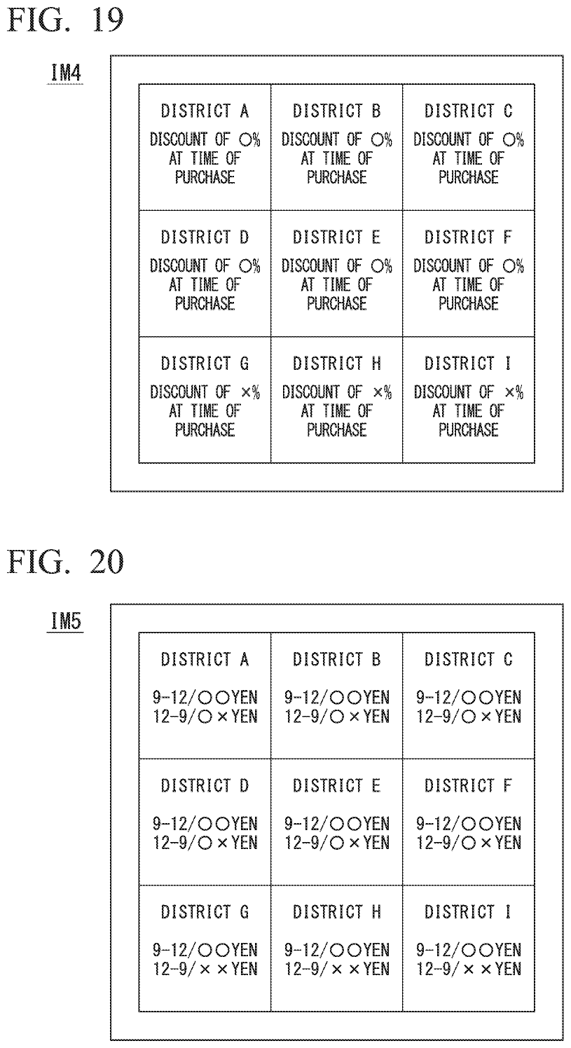

FIG. 19 is a diagram showing an example of an image IM4 including first reward distribution information displayed on a display of a terminal device 200. For example, as shown in the image IM4, when the test-driving request is performed for the test-driving for a predetermined period of time and the service receiver Ue purchases a selling target in the districts A to F, the selling target can be purchased at a discount of O % and the selling target can be purchased at a discount of X % in the districts G to I. Here, O %<X % is satisfied. For example, this is because a demand for the service provided in the districts G to I (a demand for hoping to enjoy the test-driving service) is less than a demand for the service provided in the districts A to F.

Based on the magnitude of the reward determined by the reward manager 380 and the map information included in the image generation information 402, the information generator 330 generates a second reward distribution information indicating a reward granted to the service provider Up when the test-driving service is provided in each district and transmits the generated second reward distribution information to the terminal device 100.

FIG. 20 is a diagram showing an example of an image IM5 including second reward distribution information displayed on the display of the terminal device 200. For example, as shown in the image IM5, when the test-driving service is provided for a first period of time (for example, 9:00 to 12:00) in a predetermined district, a reward of OO yen is granted to the service provider Up. When the test-driving service is provided for a second period of time (for example, 12:00 to 9:00), a reward of OX yen is granted to the service provider Up. Here, OO yen<OX yen is satisfied. For example, this is because the extent of the provision of the test-driving service for the first period of time (for example, the number of vehicles capable of providing the test-driving service) is greater than the extent of provision of the test-driving service for the second period of time.

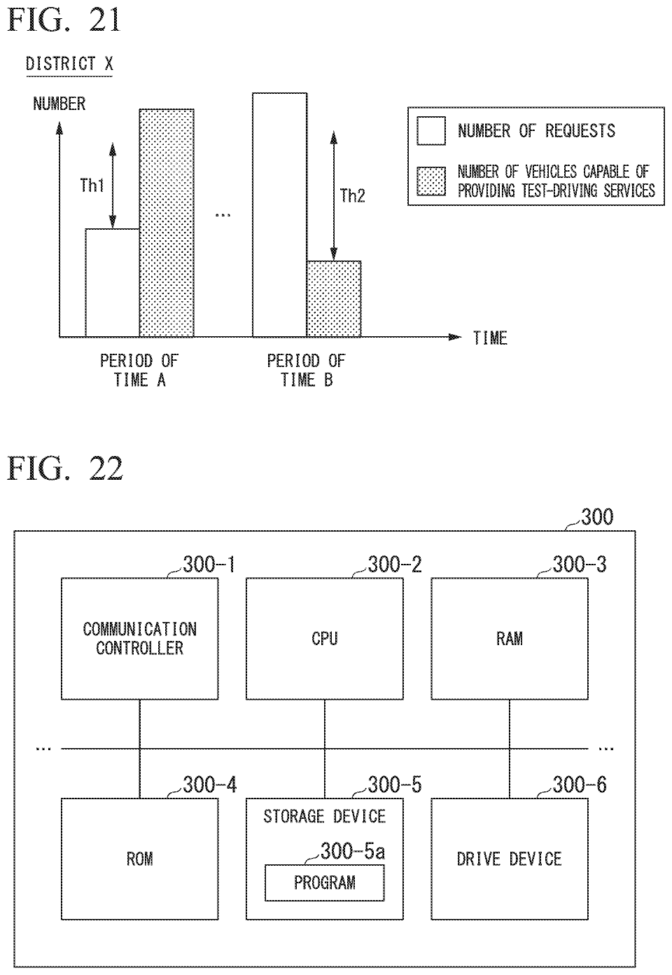

For example, the reward manager 380 determines a reward based on the following idea. FIG. 21 is a diagram showing a reward determination scheme. For example, when the number of vehicles capable of providing the test-driving service is greater than the number of demand requests by a threshold Th1 or the like for a period of time A in the district X, a supply exceeds a demand by the threshold Th1 or the like. Therefore, a reward (privilege) granted to the service receiver Ue is raised by a predetermined extent (or based on the extent in which the supply exceeds the demand) above a standard reward.

For example, when the number of requests for the period of time B in the district X is greater than the number of vehicles capable of providing the test-driving service by a threshold Th2 or the like, the demand exceeds the supply by the threshold Th2 or the like. Therefore, a reward granted to the service provider Up is raised by a predetermined extent (or based on the extent in which the demand exceeds the supply) above the standard reward.

In this way, the reward manager 380 can adjust the balance between the demand and the supply by determining the reward based on the demand and the supply for the test-driving service. Since the test-driving management device 300 can provide the test-driving service to the service receiver Ue so that the request is matched, satisfaction of a user can be improved.

According to the above-described fourth embodiment, the test-driving management device 300 can adjust the reward so that the demand or the supply is not insufficient by changing the reward in accordance with the balance between the demand and the supply. Therefore, it is possible to further promote utilization of the test-driving service.

### [Hardware Configuration]

FIG. 22 is a diagram showing an example of a hardware configuration of the test-driving management device 300 according to an embodiment. As shown, the test-driving management device 300 is configured such that a communication controller 300-1, a CPU 300-2, a random-access memory (RAM) 300-3 that is used as a working memory, a read-only memory (ROM) 300-4 that stores a boot program or the like, a storage device 300-5 such as a flash memory or a hard disk drive (HDD), a drive device 300-6, and the like are connected to each other via an internal bus or a dedicated communication line. The communication controller 300-1 performs communication with constituent element other than the test-driving management device 300. The storage device 300-5 stores a program 300-5a that is executed by the CPU 300-2. The program is loaded on the RAM 300-3 by a direct memory access (DMA) controller (not shown) or the like to be executed by the CPU 300-2. Thus, some or all of the acquirer 320, the information generator 330, the information manager 340, the reservation manager 350, the recommender 360, the assessor 370, and a reward manager 380 are realized.

The above-described embodiment can be expressed as follows:

a test-driving management device includes: a storage device configured to store a program; and a hardware processor. By executing the program stored in the storage device, the hardware processor are configured to acquire a test-driving request of a user transmitted by a terminal device; select a moving object that matches a request of the test-driving request from moving objects for test-driving registered in advance; determine whether a provider of the selected moving object responds to the test-driving request; and grant a reward provided by a selling agency of the moving object to the provider after the provider responds to the test-driving request or after the test-driving on the moving object.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A test-driving management method performed by one or more computers, the method comprising:
acquiring a test-driving request of a user transmitted by a terminal device;
selecting a moving object that matches a request of the test-driving request from moving objects for test-driving registered in advance;
determining whether a provider of the selected moving object responds to the test-driving request; and
granting a reward provided by a seller of the moving object to the provider after the provider responds to the test-driving request or after the user performs the test-driving on the moving object.

2. The test-driving management method according to claim 1, further comprising:
acquiring information regarding an action estimated to be performed by the user after the user performs the test-driving for the test-driving request; and
setting the reward based on the acquired information.

3. The test-driving management method according to claim 1, further comprising:
acquiring purchase information indicating that the user has purchased one or more moving objects, a product, and a service (hereinafter referred to as selling targets) from the seller; and
performing setting to increase the reward for the provider when the purchase information is acquired within a predetermined period after the test-driving compared with when the purchase information is not acquired within the predetermined period.

4. The test-driving management method according to claim 1, further comprising:
specifying a selling target purchased by the user among a moving object, a product, or a service (hereinafter referred to as selling targets) from the seller; and
setting the reward in accordance with the specified selling target.

5. The test-driving management method according to claim 1, further comprising:
checking a selling situation of the moving object for which the test-driving is requested in the test-driving request of the user; and
transmitting, to a terminal device, guidance for the test-driving on a moving object having a type which is similar to a type of moving object requested for the test-driving in the test-driving request of the user and is handled by the seller when the moving object requested with the test-driving request is not handled by the seller at a time point at which the test-driving request is transmitted or on a scheduled day of test-driving requested in the test-driving request.

6. The test-driving management method according to claim 5, further comprising:
acquiring information indicating whether a terminal device of a user having transmitted the guidance on the test-driving of a similar type of moving object has approved of the test-driving on the similar type of moving object; and
transmitting information regarding the seller selling the moving object for which the test-driving is requested to the terminal device of the user when the user does not approve of the test-driving of the similar type of moving object.

7. The test-driving management method according to claim 1, further comprising:
acquiring information indicating whether a provider of a moving object on which the user performs the test-driving rides together in the test-driving; and
increasing the reward when the information indicating that the provider rides together is acquired compared with when the information indicating the provider rides together is not acquired.

8. The test-driving management method according to claim 1, further comprising:
acquiring an assessment regarding a user performing the test-driving on a moving object requested with the test-driving request after the test-driving; and
acquiring an assessment regarding a provider providing the moving object requested with the test-driving request after the test-driving.

9. The test-driving management method according to claim 8, further comprising:
determining a privilege to be granted to the user or limiting a service to be provided to the user based on the assessment regarding the user.

10. The test-driving management method according to claim 1, further comprising:
setting the reward by further adding an assessment regarding a provider providing the moving object.

11. The test-driving management method according to claim 1, further comprising:
acquiring state information indicating a current state of a moving object for test-driving registered in advance;
determining whether the moving object is a candidate moving object for the test-driving requested with the test-driving request based on the acquired state information; and
performing a notification to prompt a terminal device of the provider of the moving object determined to be a candidate moving object to permit the test-driving.

12. The test-driving management method according to claim 11, further comprising:
determining whether the moving object is a moving object on which the test-driving is possible based on the acquired state information; and
performing a notification to recommend the test-driving on the moving object to a terminal device of a user who has an authority to transmit the test-driving request when the moving object is determined to be a moving object on which the test-driving is possible.

13. The test-driving management method according to claim 1, further comprising:
causing a storage to store information regarding a user performing the test-driving;
specifying a user manifesting an intention to purchase one selling target among a moving object, a product, and a service (hereinafter referred to as selling targets); and
granting a privilege of purchasing the selling target when the specified user is identical to the user stored in the storage.

14. The test-driving management method according to claim 1, further comprising:
specifying a first user who performs the test-driving and purchases a moving object;
specifying a second user who purchases a moving object without performing test-driving;
receiving registration of the purchased moving object set as a moving object for the test-driving; and
giving preference to a reward granted to the first user when the moving object registered by the first user is used for the test-driving to a reward granted to the second user when the moving object registered by the second user is used for the test-driving.

15. The test-driving management method according to claim 1, further comprising:
acquiring a first index related to the test-driving request;
acquiring a second index related to the moving object which is able to be provided in response to the test-driving request; and
adjusting first degree and second degree based on the acquired first and second indexes, the first degree being a degree of reward granted to a provider providing a moving object in response to the test-driving request, the second degree being a degree of reward granted to a receiver transmitting the test-driving request and performing test-driving on the moving object.

16. A test-driving management device, comprising:
a first acquirer configured to acquire a test-driving request of a user transmitted by a terminal device;
a selector configured to select a moving object that matches a request of the test-driving request from moving objects for test-driving registered in advance;
a determiner configured to determine whether a provider of the selected moving object responds to the test-driving request; and
a granter configured to grant a reward provided by a seller of the moving object to the provider after the provider responds to the test-driving request or after the user performs the test-driving on the moving object.
